(19) United States
(12) Patent Application Publication
(10) Pub. No.: US 2024/0316825 A1
(43) Pub. Date: Sep. 26, 2024

(54) APPARATUS FOR PROVIDING A LIQUID POLYMER COMPONENT WITH A PREDEFINED AIR CONTENT, IN PARTICULAR FOR PRODUCING A PLASTIC FOAM

(71) Applicant: HILGER U. KERN GMBH, Mannheim (DE)

(72) Inventor: Alexander Kessler, Lampertheim (DE)

(21) Appl. No.: 18/578,853

(22) PCT Filed: Jun. 29, 2022
(86) PCT No.: PCT/EP2022/067862

§ 371 Date: Jan. 12, 2024

(30) Foreign Application Priority Data
Jul. 12, 2021 (DE) 10 2021 117 879.7

(51) Int. Cl. B29B 7/74; B29B 7/60; B29B 7/72; G01N 7/00; G01N 21/64; G01N 21/84

(52) U.S. Cl. CPC B29B 7/7419; B29B 7/60; B29B 7/726; B29B 7/7428; G01N 7/00; G01N 21/643; G01N 21/84; G01N 2021/6432; G01N 2021/8416

(57) ABSTRACT

An apparatus for providing a liquid polymer component with a predefined air content, in particular for producing a plastic foam, includes a pressure vessel receiving the liquid polymer component through an opening, a pipeline at the bottom of the pressure vessel having a multiplicity of air outlet nozzles, a motor-operated stirring device, a circulation line, a pump between the inflow and outflow, and an outlet valve between the pump and the outflow. An oxygen sensor in the circulation line measures an actual value of the oxygen saturation of the air-charged polymer component, and an electronic control device modifies the pressure and/or amount of the compressed air supplied to the air outlet nozzles based on the actual value of the oxygen saturation measured by the oxygen sensor, such that the oxygen saturation of the liquid polymer component circulated in the circulation line assumes a predefined setpoint value.

The invention relates to an apparatus for providing a liquid polymer component having a predefined air content, in particular for producing a plastics foam, according to the preamble of claim 1.

In the production of permanently elastic plastics foams, which are provided by mixing two individual components, such as polyol and isocyanate, in a mixing apparatus and are applied directly to the components to be sealed, such as covers or frame parts, to create a seal before they are fully reacted, it is necessary to charge one of the two liquid polymer components—generally polyol—with a well-defined amount of air in order to obtain a desired foam consistency in the end product.

This results in the problem that the liquid polymer components are generally provided in large vessels during the mixing operation, this having the effect that the air concentration in the liquid polymer component drops when the reservoir is refilled therewith. Since a certain length of time, for example 30 minutes, is generally required to mix the introduced air with the liquid through to complete saturation, the foam quality continually changes during this time. Accordingly, it is desirable to ascertain the current air content in the liquid polymer component in order to correspondingly be able to increase or decrease it as required, in order to set the desired air content to a value which as constant as possible within as short a time as possible.

In this context, to determine the air content in the liquid polymer component of a foam system, EP 098 04 280 A1 and EP 0 451 752 A2 disclose the use of measuring cylinders with standard flasks, into which a defined amount of the polymer component, which is charged with air and removed from the reservoir, is introduced at predefined chronological intervals.

In the closed space of the measuring cylinder, the gas content in the sample taken is ascertained after removal from the reservoir by means of compression and/or decompression. The method described in EP 98 04 280 and the associated apparatus have the deficiency that the air content in the liquid polymer component cannot be determined continuously, but only batchwise. In addition, the compression and decompression of the sample taken requires a comparatively long period of time, as a result of which the inaccuracy between the ascertained air content in the sample and the actual air content in the liquid polymer component in the reservoir owing to the time offset and the non-linear saturation behavior of the air in the liquid polymer component is additionally increased.

Accordingly, an object of the present invention is to provide an apparatus for providing a liquid polymer component to which air has been added and the air proportion of which is continuously measured and can be set to a desired default value in a short period of time.

This object is achieved by an apparatus having the features of claim 1.

Further features of the invention are described in the dependent claims.

According to the invention, an apparatus for providing a liquid polymer component having a predefined air content, as is used in particular for producing a plastics foam, comprises a pressure vessel, to which the liquid polymer component is fed through an opening. The feeding is performed depending on the fill level or batchwise at predefined chronological intervals, for example every 30 minutes or once per day.

The apparatus also comprises a pipeline, preferably in the form of a tubular screw conveyor, which is arranged on the bottom of the pressure vessel and has a multiplicity of air outlet nozzles, to which air from a compressed-air source arranged outside the pressure vessel 4 can be fed with a predefined excess pressure, and the air exits from the air outlet nozzles into the interior space of the pressure vessel and is physically dissolved in the liquid polymer component.

The apparatus also comprises a motor-operated stirring device, which in particular also can be operated with a variable rotational speed and which mixes the liquid polymer component with the air exiting the air outlet nozzles, with the result that this air physically dissolves in the liquid polymer component. This constantly increases the proportion of air in the liquid polymer component according to the feed of uncharged liquid polymer component, wherein the maximally achievable saturation, or its increase per unit time, varies and depends on the air pressure in the pressure vessel, the chemical properties of the polymer component, and the temperature. During or after the mixing of the polymer component with the further liquid polymer component, the air dissolved in the liquid first polymer component forms cores for air bubbles, which form intrinsically closed cavities in the cured 2-component plastics foam that influence the permanently elastic properties and also the pore size and compressibility of the plastics foam.

The apparatus according to the invention is distinguished in that an oxygen sensor is arranged in the circulation line and measures an actual value for the oxygen saturation of the air-charged polymer component. The apparatus also comprises an electronic open-loop and closed-loop control device, which is configured to modify the pressure and/or the amount of compressed air fed to the air outlet nozzles on the basis of the actual value for the oxygen saturation in the circulation line measured by the oxygen sensor, in such a way that the oxygen saturation of the liquid polymer component circulating in the circulation line assumes a predefined setpoint value, or approaches such a predefined setpoint value. If desired, the oxygen partial pressure in the liquid polymer component can be determined mathematically from the oxygen saturation, if it is required for further applications.

The oxygen sensor used is preferably a sensor which operates according to the luminescence process. Such sensors are known, for example from EP 2 461 154. The oxygen sensor 100 is preferably mounted in the circulation line using an adapter and can as a result measure the amount of bonded oxygen in the polymer during operation “inline”, as it were, and permanently. The oxygen sensor has a photosensitive membrane as contact surface with the polymer. A phosphor located in the sensor or the membrane is excited and thereupon emits light (fluorescence). If then oxygen flows past the sensor, the emission of the phosphor is reduced in proportion to the amount of oxygen in front of the sensor, this also being referred to as the quenching effect. Software in the electronic open-loop and closed-loop control device then calculates the oxygen content in the liquid polymer component in the region behind the photosensitive membrane, preferably on the basis of the change in the phosphor emission. The oxygen content is preferably converted into a value for the amount of air bound in the polymer. Using this value for the amount of air bound in the polymer, following that the further air charge in the liquid polymer component in the pressure vessel, which at the same time is the reservoir for the liquid polymer component, is then controlled in closed-loop fashion by modifying the feed duration and/or the magnitude of the pressure of the air fed into the pipeline arranged in the pressure vessel from the outside.

As recognized by the applicant, expressed in simplified terms the basic concept of the invention is based on measuring the oxygen content physically bound in the liquid polymer continuously, or at predefined chronological intervals, and using this to ascertain the content of the air bound in the polymer. Using the amount of air bound in the polymer that was measured by the oxygen sensor, following that the air charge in the polymer is controlled in closed-loop fashion by increasing the pressure in the pressure vessel and/or modifying the amount of air fed into the vessel per unit time, in order to thereby obtain a preferably constant polymer-to-air ratio, which in turn is critical for a constant quality of the polymer foam mixture after the two polymer components have been mixed.

The invention will be described below with reference to the drawings on the basis of a preferred embodiment. In the drawings:

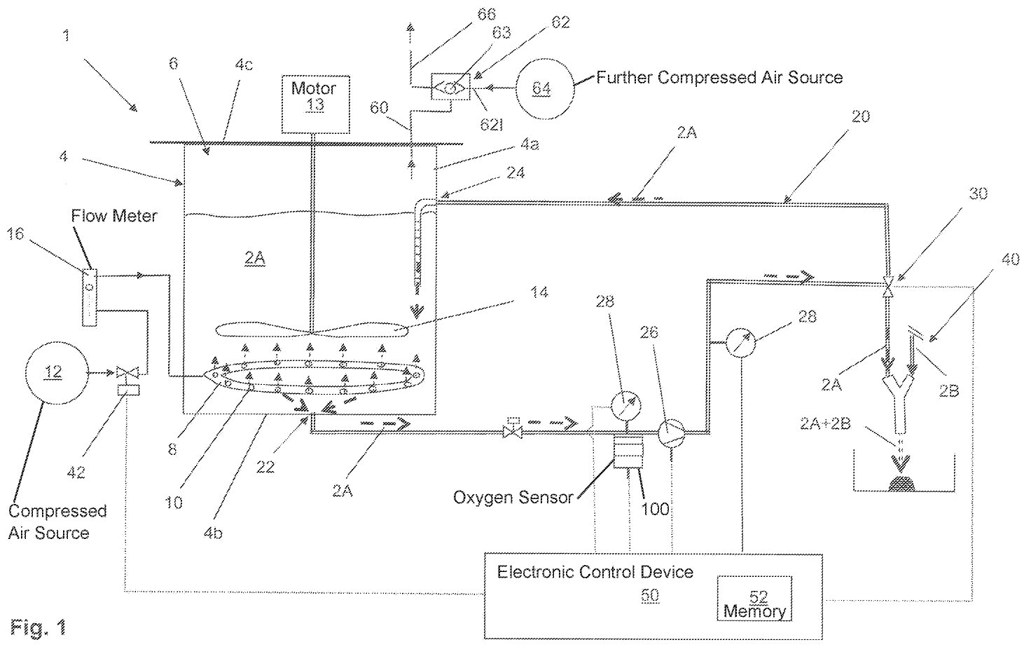

FIG. 1 shows a schematic overview of the apparatus according to the invention, and

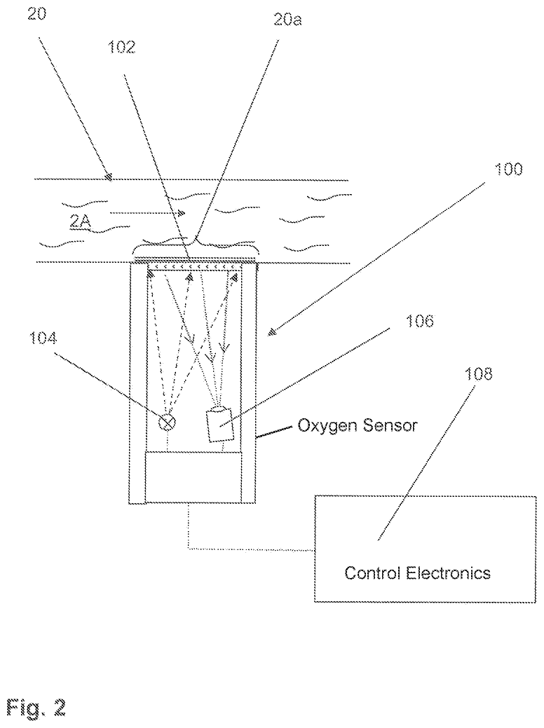

FIG. 2 shows a schematic illustration of a detail of the circulation line with the oxygen sensor arranged thereon.

As shown in FIG. 1, an apparatus 1 for providing a liquid first polymer component 2A having a predefined air content comprises a pressure vessel 4, to which the liquid polymer component 2A is fed, for example through an opening 6 closed by the cover 4c of the pressure vessel 4 or an opening, not shown, in the vessel wall 4a.

As shown in FIG. 1, a pipeline 8 is arranged in the region of the bottom 4b of the pressure vessel 4 and has a multiplicity of air outlet nozzles 10, to which air is fed from a compressed-air source 12, for example a compressed-air compressor, arranged outside the pressure vessel 4 with a predefined excess pressure. This air flows out of the air outlet nozzles 10 and is physically dissolved in the first polymer component 2A stored in the interior space of the pressure vessel 4.

The apparatus 1 also has a stirring device 14, which is operated by a motor 13, is indicated by a schematic rotor in FIG. 1, and mixes the liquid polymer component 2A with the compressed air exiting the air outlet nozzles 10, with the result that this compressed air physically dissolves in the liquid polymer component 2A and its air proportion, which forms cores for air bubbles when the polymer component is being mixed with a further liquid polymer component 2B, accordingly continuously increases.

As can also be deduced from the illustration of FIG. 1, the interior space of the pressure vessel 4 is fluidically connected to a circulation line 20 via an inflow 22 arranged in the region of the bottom 4b of the pressure vessel 4, through which circulation line the liquid polymer component 2A is circulated back to an outflow 24, which is located above the inflow 22, by means of a pump 26. As illustrated, the outflow 24 preferably comprises a vertical pipe section, which extends downstream from the passage opening, not designated in more detail, in the container wall 4a and is preferably located underneath the liquid surface of the liquid polymer component 2A. This ensures that the liquid 2A circulating back to the pressure vessel 4 via the outflow 24 flows counter to the rising amount of air from the air exit nozzles 10 (countercurrent principle), as a result of which the charge of air in the liquid polymer component 2A is advantageously improved.

Arranged between the pump 26 and the outflow 24 is a known outlet valve 30, through which the air-charged liquid polymer component 2A can be fed to a known mixing device 40, in order to mix the first liquid polymer component 2A with the further liquid polymer component 2B in a mixing device 40, which is symbolically indicated by a Y-shaped line, in the known way. The intermixed polymer components 2A, 2B, which exit the mixing device 40 in the form of a liquid, uncured plastics foam 2A+2B, are preferably continuously deposited directly in the form of a bead onto a component, such as a cover or a door, on which the plastics foam mixture forms, for example, a correspondingly permanently elastic seal after curing. The first liquid polymer component 2A, which is charged with a predefined amount of air for core formation in the apparatus 1 according to the invention, May for example be polyol, and the second polymer component 2B is isocyanate in this case.

An oxygen sensor 100 is arranged in the circulation line 20 and preferably continuously measures an actual value for the oxygen saturation of the air-charged polymer component 2A. The apparatus 1 also comprises an electronic open-loop and closed-loop control device 50, which is connected to the oxygen sensor 100 and also the pump 26, which is preferably a metering pump, and an open-close valve 42 via lines, not designated in more detail, which open-close valve makes it possible to modify the pressure and/or the amount of compressed air fed to the air outlet nozzles 10 from the compressed-air source 12 on the basis of the actual value for the oxygen saturation in the circulation line 20 measured by the oxygen sensor 100. To this end, the pressure and/or the amount of the compressed air fed to the air outlet nozzles is increased, or decreased, in such a way that the oxygen saturation in the liquid polymer component 2A circulating in the circulation line 20 assumes a predefined setpoint value, or approaches such a predefined setpoint value.

In one embodiment of the invention, the aforementioned open-close valve 42 is opened and closed again by the electronic open-loop and closed-loop control device 50 for a predefined period of time, for example for 5 minutes, and the length of this period of time is increased for example by 10% or a fixed time value, for example 10 seconds, if the actual value for the oxygen saturation measured by the oxygen sensor 100 is less than the preferably empirically ascertained setpoint value. Opening the open-close valve 42 causes compressed air to flow from the compressed-air source 12 into the pipeline 8, preferably via a flow meter 16, and, through the air outlet nozzles 10, enter the liquid polymer component 2A, in which some of the air is physically dissolved depending on the pressure inside the pressure vessel 4, the current degree of saturation and the temperature in the liquid polymer component. The undissolved portion of the fed air rises and exits at the top side of the pressure container 4 through an air outlet channel 60, which can be closed by a pressure regulating valve.

In a correspondingly converse manner, the duration for which the compressed air flows through the open-close valve from the compressed-air source 12 into the pressure vessel 4, and thus the amount of fed air, is shortened by the electronic open-loop and closed-loop control device 50 if the current actual value measured by the oxygen sensor 100 exceeds the setpoint value. If the actual value is the same or substantially the same as the setpoint value for the oxygen saturation, the valve 42 is preferably closed until the feed of uncharged first liquid polymer component 2A starts again.

As indicated in FIG. 1, the pressure vessel 4 has an air outlet channel 60, which is arranged in the vessel wall 4a or in the vessel cover 4c, fluidically communicates with the air volume located in the pressure vessel 4 above the liquid polymer component 2A, and is fluidically connected to the surrounding area via a pressure regulating valve 62 which opens if the pressure inside the pressure vessel 4 exceeds a predefined maximum pressure.

The pressure regulating valve 62 is preferably a pneumatically controllable 3/2-way valve, to the control input 62I of which a predefined variable control pressure from a further compressed-air source 64 can preferably be applied. The fluidic connection between the interior space of the pressure vessel 4 and the surrounding area is opened up by the pressure regulating valve 62 if the pressure in the interior space of the pressure vessel 4 exceeds the control pressure, which can be set sensitively and preferably mechanically to 4 bar, for example via a needle valve, which is not shown in more detail. As is indicated purely schematically in FIG. 1, the valve body 63 in the pressure regulating valve 62 is displaced into the valve seat, not designated in more detail, by the prevailing control pressure of the further compressed-air source 64 in order to prevent the compressed air exiting the interior space of the pressure vessel 4 into the downstream air outlet channel 60 and, through that, into the surrounding area.

This embodiment of the invention has the advantage that the pressure in the interior space of the pressure vessel 4 can be advantageously set very sensitively to a predefined value without a complex electronic pressure regulating device being required for this, although one can also be used as an alternative. At the same time, it is ensured that the compressed air which was introduced into the pressure vessel 4 from the compressed-air source 12 during the aforementioned 11 chronological interval and may have a pressure of 4.5 bar or more can exit from the interior space of the pressure vessel 4 at all when the control pressure of the further compressed-air source 64 is exceeded. This is the basic prerequisite for a substantially constant air stream in the liquid polymer component 2A, which considerably facilitates the closed-loop control to a predefined setpoint value for the oxygen saturation of the liquid polymer component 2A and advantageously increases the closed-loop control accuracy.

It can be seen as a further advantage of the embodiment of the invention described above that the pressure regulating valve 62 is automatically closed, as it were, if the pressure in the pressure vessel 4 undershoots the control pressure owing to the air flowing continuously from the air outlet channel 60 after the open-close valve 42 of the compressed-air source 12 has been closed, without any additional electronically actuated valves or other components being required for this.

According to a further concept on which the invention is based, at least one pressure sensor 28, shown in FIG. 1, is arranged in the circulation line 20 and measures the pressure of the air-charged liquid polymer component in the circulation line 20 to calibrate the oxygen sensor 100. This makes it possible to calibrate the oxygen sensor 100 with high accuracy and, as a result, the measurement accuracy with which the oxygen saturation of the liquid polymer component 2A can be determined is increased further overall.

In a preferred embodiment of the invention, the pressure sensor 28 and the oxygen sensor 100 are arranged upstream of the pump 26, that is between the outflow 24 of the pressure vessel 4 and the pump 26 in the circulation line 20. This results in the advantage that pressure fluctuations in the circulation line 20 that are caused by removing the liquid polymer component 2A in the mixing device 40 do not influence, or have a considerably reduced influence, on the pressure of the liquid polymer component 2A when the oxygen saturation is being determined in 9 the oxygen sensor 100. This makes it possible for the oxygen sensor to measure, with high accuracy, the actual value for the oxygen saturation of the liquid polymer component 2A even while the liquid polymer component 2A is being fed to the mixing device 40, as a result of which quality fluctuations in the finished foam 13 mixture that result from an excessively high or low oxygen proportion in the liquid polymer component 2A, can be counteracted already in good time. The pressure sensor 28 is particularly preferably arranged at the level of the oxygen sensor 100 on the opposite side of the circulation line 20. At the same time or alternatively, it may be arranged downstream of the pump/metering pump 26, as is likewise indicated schematically in FIG. 1. It may also be provided for a shutoff tap, preferably a mechanically actuated ball valve, to be arranged in the circulation line 20 upstream of the oxygen sensor 100, by means of which the flow of the liquid polymer component 2A can be interrupted in the event of a fault, or to externally operate the apparatus 1 by hand.

In the preferred embodiment of the invention, the oxygen sensor 100 has a photosensitive membrane 102 containing phosphor, which forms an inner wall portion 20a of the circulation line 20, as shown in FIG. 2. The air-charged liquid polymer component 2A comes into direct contact with the phosphor when it flows through the circulation line 20. The oxygen sensor 100 also comprises a light source 104, for example an LED, which irradiates the photosensitive membrane with electromagnetic radiation, preferably shortwave blue light. The oxygen sensor 100 also contains an optical sensor 106, which detects the light emitted by the irradiated membrane 102 and is connected to associated control electronics 108, which generate an electrical signal, the value of which is a measure for the oxygen saturation of the liquid polymer component 2A, from the light detected by the optical sensor 106. Such oxygen sensors are known in the prior art, for example from the aforementioned EP 2 461 154 A1, and can be referred to in trade as finished units.

In order to determine the actual value for the amount of air present in the liquid polymer component 2A as an absolute value, the electronic open-loop and closed-loop control device 50 is advantageously configured to determine the amount of air present in the liquid polymer component 2A per unit volume or per unit mass of the liquid polymer component 2A as an absolute value from the actual value for the oxygen saturation ascertained by the oxygen sensor 100 and the sensor electronics 108 coupled thereto. This absolute value may then be fed in the known way as control parameter to an electronic controller, for example a PID controller, which is preferably implemented in the electronic open-loop and closed-loop control device 50 as software. To this end, the electronic open-loop and closed-loop control device 50 is configured to determine the amount of air present in the liquid polymer component 2A per unit volume and/or per unit mass on the basis of values for the oxygen saturation that were ascertained empirically by measurements beforehand and to determine the associated amount of air present in the liquid polymer component 2A, and these amounts of air can be stored in a memory 52 of the electronic open-loop and closed-loop control device 50. The values for the oxygen saturation and the amount of air per unit volume/unit mass are preferably determined beforehand on the basis of compression-decompression measurements, as are described for example in EP 098 04 280 A1 or EP 0 451 752 A2, and stored permanently in the memory 52 as pairs of values.

### LIST OF REFERENCE SIGNS

1 Apparatus according to the invention
2A Liquid polymer component
2B Further polymer component
4 Pressure vessel
4a Vessel wall
4b Bottom
4c Vessel cover
6 Vessel opening
8 Pipeline
10 Air outlet nozzles
12 Compressed-air source
13 Motor
14 Stirring device
16 Flow meter
20 Circulation line
20a Inner wall portion
22 Inflow
24 Outflow
26 Pump
28 Pressure sensor
30 Outlet valve
40 Mixing device
42 Open-close valve
50 Electronic open-loop and closed-loop control device
52 Memory of the electronic open-loop and closed-loop control device
60 Air outlet channel
62 Pressure regulating valve
62I Control input of the pressure regulating valve
63 Valve body
64 Further compressed-air source
66 Air outlet
100 Oxygen sensor
102 Photosensitive membrane
104 Light source
106 Optical sensor
108 Sensor electronics

1-9. (canceled)

10. An apparatus for providing a liquid polymer component having a predefined air content, the apparatus comprising:
a pressure vessel having a bottom, an interior space, and an opening for feeding the liquid polymer component into said pressure vessel;
a compressed-air source disposed outside said pressure vessel;
a pipeline or a tubular screw conveyor disposed at said bottom of said pressure vessel, said pipeline having a multiplicity of air outlet nozzles receiving air from said compressed-air source at a predefined pressure, permitting the air to exit said air outlet nozzles into said interior space of said pressure vessel;
a motor-operated stirring device mixing the liquid polymer component with the air exiting said air outlet nozzles;
a circulation line having an inflow disposed in a region of said bottom of said pressure vessel and an outflow disposed above said inflow;
a pump disposed between said inflow and said outflow for conveying the polymer component charged with air through said circulation line from said inflow to said outflow;
a mixing device;
an outlet valve disposed between said pump and said outflow and permitting the air-charged liquid polymer component to be fed to said mixing device for mixing with a further polymer component;
an oxygen sensor disposed in said circulation line for measuring an actual value for an oxygen saturation of the air-charged polymer component; and
an electronic control device configured to modify at least one of a pressure or an amount of compressed air fed to said air outlet nozzles based on the actual value for the oxygen saturation measured by said oxygen sensor, causing the oxygen saturation of the liquid polymer component circulating in said circulation line to assume a predefined setpoint value.

11. The apparatus according to claim 10, wherein said mixing device produces a plastic foam.

12. The apparatus according to claim 10, which further comprises:
an open-close valve configured to be actuated by said electronic control device;
said compressed-air source configured to be fluidically connected to said pipeline through said open-close valve; and
said electronic control device opening said open-close valve for a predefined period of time upon the actual value measured by said oxygen sensor being less than the setpoint value for the oxygen saturation.

13. The apparatus according to claim 10, which further comprises a pressure sensor disposed in said circulation line, said pressure sensor measuring a pressure of the air-charged liquid polymer component in said circulation line to calibrate said oxygen sensor.

14. The apparatus according to claim 13, wherein said pressure sensor and said oxygen sensor are disposed upstream of said pressure vessel in said circulation line.

15. The apparatus according to claim 10, which further comprises:
a pressure regulating valve opening upon a pressure inside said pressure vessel exceeding a predefined maximum pressure;
said pressure vessel having a vessel wall, a vessel cover, and an air outlet channel disposed in said vessel wall or in said vessel cover;
said air outlet channel fluidically communicating with an air volume provided in said pressure vessel above the air-charged liquid polymer component; and
said air outlet channel being fluidically connected to a surrounding area through said pressure regulating valve.

16. The apparatus according to claim 15, which further comprises:
a further compressed-air source;
said pressure regulating valve being a pneumatically controllable 3/2-way valve having a control input configured to receive a predefined variable control pressure from said further compressed-air source;
said pressure regulating valve opening a fluidic connection between said interior space of said pressure vessel and surroundings upon the pressure in said interior space of said pressure vessel exceeding the control pressure.

17. The apparatus according to claim 10, wherein:
said oxygen sensor includes a photosensitive membrane containing a luminous phosphor forming an inner wall portion of said circulation line and coming into contact with the air-charged liquid polymer component when the air-charged liquid polymer component flows through said circulation line;
said oxygen sensor includes a light source configured to irradiate said photosensitive membrane with electromagnetic radiation;
said oxygen sensor includes an optical sensor detecting light emitted by said irradiated photosensitive membrane; and
sensor electronics are coupled to said optical sensor and generate, from light detected by said optical sensor, an electrical signal having a value being a measure for the oxygen saturation of the liquid polymer component.

18. The apparatus according to claim 17, wherein said electronic control device is configured to determine an amount of air present in the liquid polymer component per unit volume or per unit mass of the liquid polymer component from the value being a measure for the oxygen saturation.

19. The apparatus according to claim 18, wherein:
said electronic control device is configured to determine the amount of air present in the liquid polymer component per at least one of unit volume or unit mass based on values for the oxygen saturation having been ascertained empirically by measurements beforehand and to determine an associated amount of air present in the liquid polymer component; and
said electronic control device has a memory configured to store the amounts of air.
